(19) United States
(12) Patent Application Publication
(10) Pub. No.: US 2021/0014109 A1
(43) Pub. Date: Jan. 14, 2021

(54) UPDATE TO OPTICAL NETWORKING UNIT (ONU) VIA AN INSTRUCTION FILE

(71) Applicant: ARRIS Enterprises LLC, Suwanee, GA (US)

(72) Inventor: Jashua Richard Cloutier, Boca Raton, FL (US)

(21) Appl. No.: 16/919,695

(22) Filed: Jul. 2, 2020

Related U.S. Application Data
(60) Provisional application No. 62/871,707, filed on Jul. 9, 2019.

(51) Int. Cl. H04L 12/24; H04B 10/27; H04L 29/08

(52) U.S. Cl. CPC H04L 41/082; H04L 67/06; H04B 10/27

(57) ABSTRACT

In one embodiment, a method receives a first file for an update to a configuration. The first file is sent via an operations, administration, and management message over an optical network. A specification is used to provision an optical networking unit includes a requirement that the operations, administration, and management message is to be used to update the configuration. The method analyzes the first file to determine the first file includes an instruction for locating a second file that includes an update to the configuration and extracts download information for the second file from the first file. The method then uses the download information to request and download the second file via a data connection over the optical network. The data connection includes a first transfer rate that is higher than a second transfer rate when using operations, administration, and management messages.

### CROSS-REFERENCES TO RELATED APPLICATIONS

This application claims priority to U.S. Provisional Patent Application No. 62/871,707 filed on Jul. 9, 2019, entitled “UPDATE TO OPTICAL NETWORKING UNIT (ONU) VIA AN INSTRUCTION FILE”, the disclosure of which is hereby incorporated by reference.

### BACKGROUND

Optical networking units (ONUs) were typically updated using software image files that were very small, such as 100 kilobytes (kb). A standard, such as the Data Over Cable Service Interface Specification (DOC SIS) Provisioning of Ethernet Passive Optical Network (DPoE), specifies that the software update of the ONU should be performed using operations, administration, and management (OAM) messages. The update method sends a software image (e.g., firmware) from an optical line terminal (OLT) to the ONU via OAM messages. The sending of OAM messages is different from sending data via the optical connection between the OLT and the ONU. For example, the data connection via the optical network may transfer data in one gigabit or ten gigabit per second speeds while the default OAM message rate is ten messages per second resulting in a transfer rate of 150 k messages per minute. Presently, the file needed to update the ONU is much larger than 100 kb. This means that the OLT needs to transfer a much larger file via OAM messages at the slower message rate. The slower transfer rate means that updating an ONU may take a long time. Further, a large number of ONUs, such as tens of hundreds of ONUs, may be connected to an OLT, and that OLT can only update a limited number of ONUs at a time. Thus, the whole update process may take several days given the limited OAM message transfer rate.

### BRIEF DESCRIPTION OF THE DRAWINGS

FIG. 1 depicts a simplified system for updating devices according to some embodiments.

FIG. 2 depicts a simplified flowchart of a method for processing an update at an OLT according to some embodiments.

FIG. 3 depicts a more detailed example of performing the update of an ONU configuration according to some embodiments.

FIG. 4 depicts a more detailed example of processing the instruction file according to some embodiments.

FIG. 5 illustrates an example of special purpose computer systems configured with the OLT or the ONU according to some embodiments.

### DETAILED DESCRIPTION

Described herein are techniques for a networking system. In the following description, for purposes of explanation, numerous examples and specific details are set forth in order to provide a thorough understanding of some embodiments. Some embodiments as defined by the claims may include some or all of the features in these examples alone or in combination with other features described below, and may further include modifications and equivalents of the features and concepts described herein.

An optical line terminal (OLT) uses a type of communication, such as using an operations, administration, and management (OAM) message, to send an instruction file that includes instructions on where to download an update file. Using the OAM message complies with a specification or protocol that requires the use of OAM messages how to update a configuration of an optical networking unit (ONU) using a file transfer messages. As discussed in the Background, due to the slow message transfer rate that is defined for OAM messages by the specification and the large update file that needs to be downloaded to the ONU, using OAM messages to transfer the update file from the OLT to the ONU takes a long time. However, the instruction file is small and can often be sent in a single packet or message. Then, the ONU can use the instructions in the instruction file to determine how to download the update file from another device, such as a server. The ONU may use a data communication system, such as a system that includes an Internet protocol (IP) stack, that can request data from the server. Requesting the data from the server uses the regular data transfer rate for transferring data from the OLT to the ONU via an optical network. This data rate is typically much faster than the transfer rate for the OAM messages, such as a transfer rate of one gigabyte to ten gigabytes compared to a transfer rate for OAM messages of 150 kb messages/minute. Accordingly, the ONU can update its ONU configuration faster using the download of the update file via the data connection link, but also comply with the specification of using an OAM message to perform the update of the ONU configuration. This also allows the OLT to update a large amount of ONUs simultaneously and finish the update of the ONUs much faster compared to just using OAM messages.

System Overview

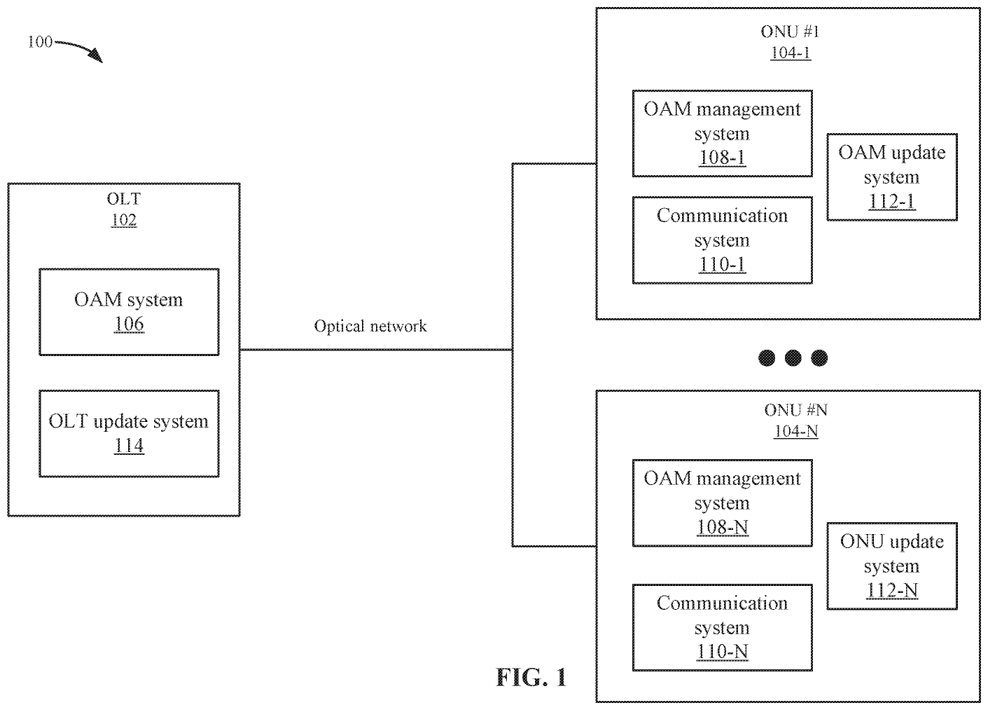

FIG. 1 depicts a simplified system 100 for updating devices according to some embodiments. System 100 includes a first device, such as an OLT 102, and second devices that are updated, such as optical networking units (ONUs) 104-1 to 104-N, which n is a number that indicates multiple ONUs may be coupled to OLTs 102. Also, although OLTs and ONUs are discussed, any devices that communicate via an optical network may be appreciated.

OLT 102 may be located in a headend and sends data and/or voice downstream through an optical network to ONUs 104. In some embodiments, OLT 102 may serve the same purpose as a cable modem termination system (CMTS). ONU 104 is configured to receive optical signals and convert the optical signals to electrical signals (e.g., radio frequency signals). ONU 104 can then send the electrical signals to consumer premise equipment (CPE) or other subscriber devices (not shown). In some embodiments, ONU 104 is similar to a cable modem and is generally located close to the customer premise equipment. Also, ONU 104 may also receive data from customer premise equipment and convert the data from electrical signals to optical signals and send the optical signals upstream to OLT 102.

OLT 102 may be coupled to multiple ONUs 104-1 to 104-N. One ONU 104 will be described below, but the process may be used to update multiple ONUs 104. The optical network may be a passive optical network that transmits data via fiber-optic cables. The optical network may be split to connect a single OLT 102 to multiple ONUs 104-1 to 104-N. OLT 102 may multiplex optical signals via the time domain and send the optical signals via the optical network (e.g., a passive optical network) to ONUs 104-1 to 104-N. ONUs 104-1 to 104-N may then select their own data through labels embedded in the optical signals.

Before ONUs 104 can receive and transmit data, ONUs 104 are provisioned. A specification may be used to perform the provisioning, such as the Data Over Cable Service Interface Specification (DOCSIS) Provisioning of Ethernet Passive Optical Network (DPoE) specification may be used to perform the provisioning of ONUs 104-1 to 104-N. The provisioning may download and update a software configuration for ONU 104, if needed, that is used by ONUs 104-1 to 104-N to transmit and receive data in the system. For example, the software update may be a firmware update for ONUs 104-1 to 104-N, which may update an operating system or other software of the ONU. In some embodiments, ONUs 104-1 to 104-N need to be updated with the appropriate configuration to send and receive data via the optical network. The configuration is different from data that is sent to customer premise equipment in that the configuration is installed at ONU 104.

As OLT 102 is coupled to multiple ONUs 104, a single OLT 102 may be responsible for updating the configuration of multiple ONUs 104. To update the configuration of an ONU 104, OLT 102 may use an OLT update system 114 and an OAM system 106. OLT update system 114 may prepare the update to be performed. The specification may specify a specific way to update the configuration of ONUs 104 is by using OAM messages, such as the specification may use a secure software download (SSD) process using OAM messages. The update may be sent using the File Transfer mechanism as described in the DPoE specification. For example, DPoE extensions enable ONUs to download new firmware upgrades and other files from the DPoE System using a simple file transfer protocol. Accordingly, OAM system 106 may send an OAM message to ONU 104 to update the configuration. The OAM message is a special type of message that may be defined in the specification to perform management of ONU 104. As discussed above, OAM messages are specially transmitted that end up being transmitted at a different message rate than other data that is being sent via the optical network. For example, data that is being downloaded to ONU 104 may end up being sent at a first data rate, such as a one gbps data rate while an OAM message from management of ONU 104 may end up being sent at a slower data rate, such as 150k messages/minute. The OAM messages are interleaved with the other packets based on different Ethernet headers and are sent very infrequently. One difference between an OAM message and a data download is that the data download is data that is sent to a CPE from ONU 104 while an OAM message is used to manage some aspect of ONU 104 and not sent to a CPE.

ONU 104 includes an OAM management system 108 that can receive and process OAM messages. Conventionally, an update file is sent via OAM messages from OAM system 106 in OLT 102 to ONU 104. The update file may be a large file that requires multiple OAM messages to be sent between OAM system 106 and OAM management system 108. One reason why the contents of the update file is sent via OAM messages is the specification indicates that the update should be performed via OAM messages. To overcome the slow download of the update file, some embodiments use the OAM system 106 to send an instruction file to OAM management system 108. The instruction file includes instructions on how ONU 104 can download the update file. Typically, the instruction file is a lot smaller than the update file and does not take a long time to send from OAM system 106 to OAM management system 108.

Upon receiving the instruction file, OAM update system 112 processes the update. For example, OAM update system 112 can receive and process the instruction file to determine how to download the update file. Then, a communication system 110 is used to download the update file, such as via a server. The server may be a different computing entity from OLT 102, such as the server is not in the head end and managing communications with ONU 104. Communication system 110 may use an Internet protocol (IP) stack to download the file from a server via the optical network. This download uses the regular transfer rate for data and avoids the restriction on the message rate for OAM messages. Accordingly, communication system 110 can download the update file much faster using the regular transfer rate.

The above update process complies with the specification by using an OAM message to initiate the update of the ONU configuration. However, OLT 102 does not include the full contents of the update file in the instruction file or use additional OAM messages after sending the instruction file to update ONU 104. Using another method other than sending OAM messages to update the ONU configuration is much faster than using OAM messages and allows OLT 102 to update a large amount of ONUs 104-1 to 104-N in parallel and much faster.

OLT Processing

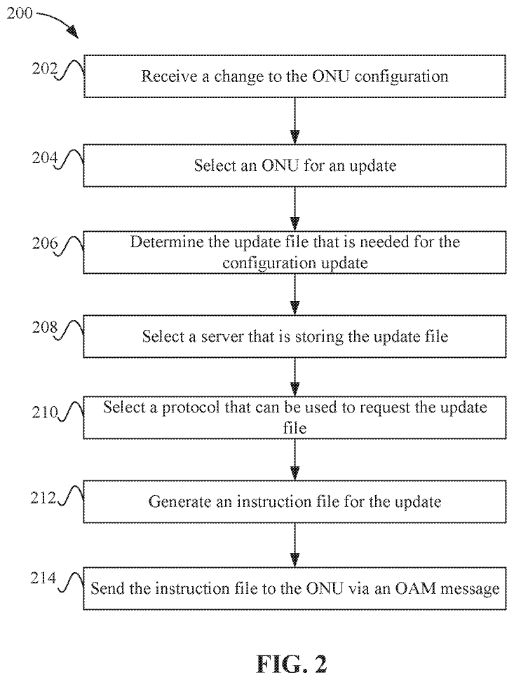

The following will describe processing at OLT 102 according to some embodiments. FIG. 2 depicts a simplified flowchart 200 of a method for processing an update at OLT 102 according to some embodiments. When an update to an ONU configuration occurs, at 202, OLT 102 receives a change to the ONU configuration. For example, an operator may decide to update the firmware for an ONU 104. The update may specify specific ONUs, model numbers of ONUs, or other information that can be used to select ONUs.

OLT update system 114 may have previously received an initialization request with device information for ONU 104. The initialization request may be received via an OAM message at OLT update system 114. The device information may indicate a configuration version that ONU 104 is currently using and other information, such as information identifying ONU 104. The request may be received when ONU 104 is first initialized on the optical network, or when ONU 104 powers up and connects to OLT 102 at a time after being initialized on the optical network. Additionally, the initialization request may be received at other times, such as periodically over time when ONU 104 should check for configuration updates.

At 204, OLT update system 114 selects an ONU 104 for an update. For example, the analysis may involve comparing a software configuration of ONU 104 to a current software configuration that is set by the operator. For example, OLT update system 114 compares version numbers of the software configurations.

At 206, OLT update system 114 determines the update file that is needed for the configuration update. For example, OLT update system 114 may use the identifier for ONU 104 to select the appropriate update file for that ONU 104. Different versions of the configuration may be available and ONU 104 is updated to one of the versions. The instruction file is different from the update file in that the instruction file includes an instruction of where to download the update file. The update file may not include an instruction of where to download the update file because that file includes the update.

At 208, OLT update system 114 then selects a server that is storing the update file. Different servers may be used to store the update files. OLT update system 114 may select a server that can service ONU 104.

At 210, OLT update system 114 selects a protocol that can be used to request the update file. For example, one protocol that may be used is hypertext transfer protocol (HTTP). However, other protocols may be used. OLT update system 114 may determine the protocol based on what types of communication ONU 104 can use. For example, if ONU 104 includes an IP stack, then HTTP may be used as the protocol.

At 212, OLT update system 114 generates an instruction file for the update. The instruction file may include the server location, the protocol, and the file identifier for the update file. The above processing may not be performed by OLT update system 114 if the instruction file is received from the operator. In this case, OLT update system 114 retrieves the instruction file.

Then, at 224, OAM system 106 sends the instruction file to ONU 104 via an OAM message. The instruction file may not include contents of the update file that are used to update the software configuration of ONU 104. Rather, the instruction file includes instructions on where to download the update file. Accordingly, the instruction file can be much smaller than the update file, and OAM system 106 can finish transmission of the instruction file much faster than sending the update file via OAM messages.

ONU Processing

The following will describe the processing of ONU 104. The following processing may be performed at multiple ONUs, but the processing is described with respect to one ONU 104.

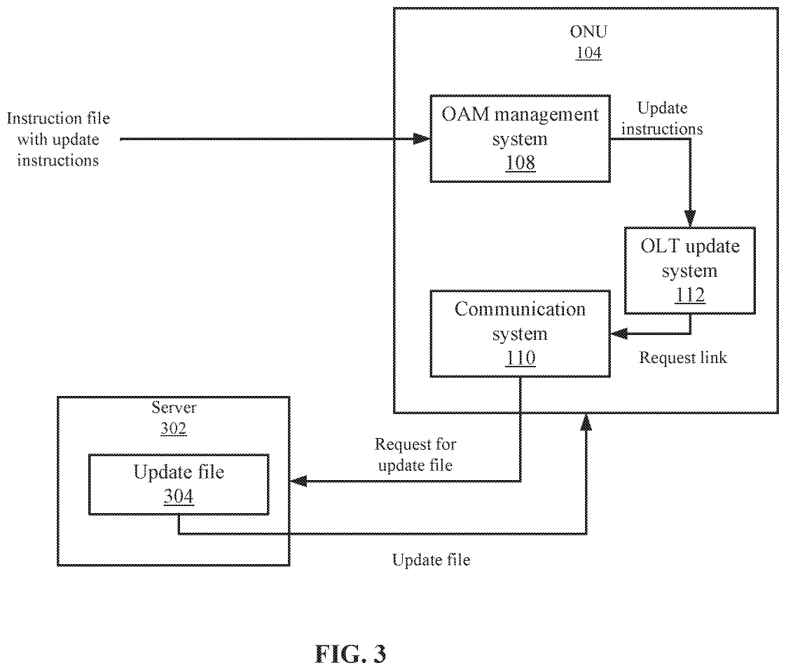

FIG. 3 depicts a more detailed example of performing the update of an ONU configuration according to some embodiments. When an operator decides to update the ONU configuration, the operator may store an update file 304 on a server 302. Server 302 may be an HTTP download server that can be called via an HTTP link. Then, the operator may store an instruction file at OAM system 106, which is sent to ONU 104. In some embodiments, server 302 and OLT 102 are different entities. That is, server 302 sends data through OLT 102 to ONU 104.

OAM management system 108 at ONU 104 receives the instruction file with update instructions. OAM management system 108 may then review the update instructions in the instruction file and determine that instructions to download the update file are included in the instruction file instead of content for the update. OAM management system 108 may make this determination in different ways, such as a flag may be set in the instruction file indicating that this instruction file includes an instruction to download the update file rather than the content of the update file.

When OAM management system 108 receives the instruction file, OLT update system 114 may then generate download information, such as a request link, that can be used to download the update file. The request link may be found in the instruction file, or may OLT update system 114 may derive the link via the instructions in the instruction file. Then, communication system 110 uses the request link to send a request for the file. Communication system 110 may use the data download connection to request the update file via the optical network. The data download connection is different from receiving the OAM messages and does not have the message rate restrictions of the OAM messages. In some embodiments, communication system 110 uses an IP stack to send an HTTP request for the update file to server 302. The HTTP request is directed to server 302 and identifies an update file. OLT 102 may process the request and send the request to server 302.

Once server 302 receives the request for the update file, server 302 retrieves the appropriate update file via a file identifier and sends update file 304 to ONU 104. Server 302 sends the update file 304 via the optical network to ONU 104 using the data connection, which may be through OLT 102. This avoids downloading the content of the update file using OAM messages, but still complies with the specification that requires updates to the configuration to be performed using an OAM message.

Once receiving the update file, ONU 104 may update the ONU configuration and then reboot. Upon rebooting, ONU 104 notifies OLT 102 of the software configuration it is running, which is approved by OLT 102. ONU 104 is then initialized for the service.

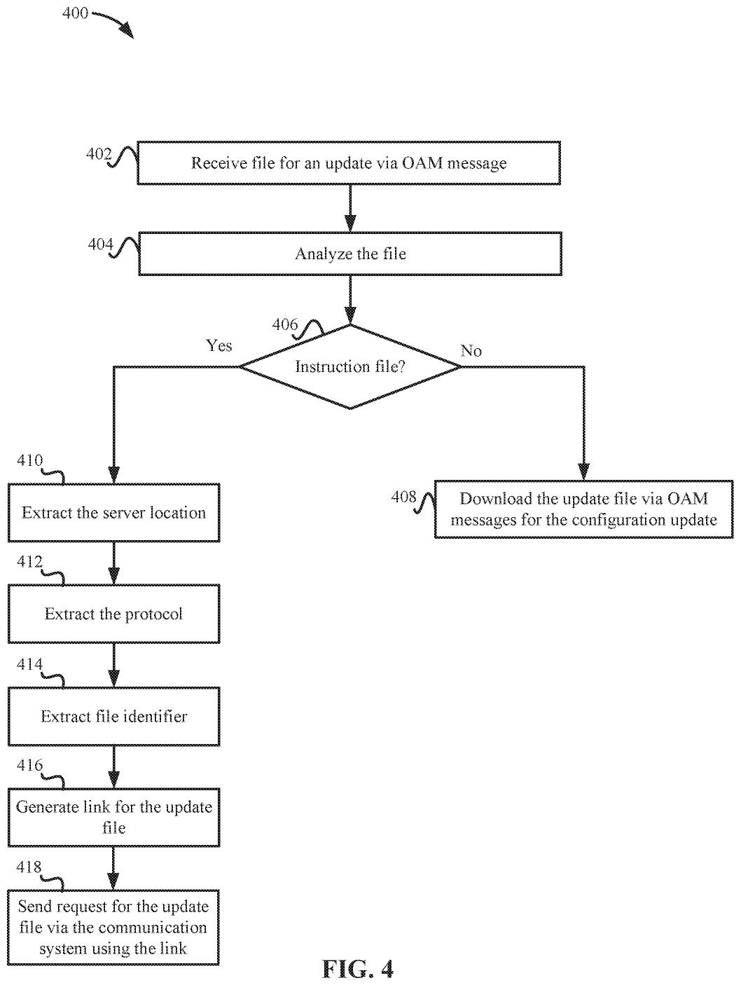

FIG. 4 depicts a more detailed example of processing the instruction file according to some embodiments. The following describes a scenario where an initial file received from OAM system 106 may include the update file or the instruction file.

At 402, ONU 104 receives a file for an update via an OAM message. Since the file can be an update file or an instruction file, at 404, ONU 104 analyzes the file to determine the type of file. For example, ONU 104 may review the file to determine if information is set to indicate this is an update file. The information may be X bytes in a header that have a certain value to indicate the file is an instruction file, or a flag that is set to a certain value. Then, at 406, ONU 104 determines if the file is an instruction file. If not, at 408, ONU 104 downloads the update file for the configuration update via OAM messages. ONU 104 may also receive additional OAM messages to download other parts of the configuration update of the update file. It is noted that ONU 104 may be configured to only receive instruction files and does not need to perform the above analysis to determine whether an instruction file is sent.

If ONU 104 determines an instruction file has been sent, at 410, ONU 104 extracts the server location from the instruction file. The server location may be an identifier for server 302 or a link, such as an HTTP link. Then, at 412, ONU 104 extracts the protocol to use to send the request. For example, the protocol may be HTTP. Finally, at 414, ONU 104 extracts a file identifier for the update file. The file identifier may identify the correct version of the update file for the configuration. It is noted that ONU 104 may extract all three of the above together, such as by extracting a link to use to download the update file.

At 416, using the above information, ONU 104 generates a link for the update file. For example, the link may be an HTTP link that routes a request to server 302 and identifies update file 304. At 418, ONU 104 sends a request for the update file via communication system 110 using the link.

### CONCLUSION

Accordingly, updates to ONUs 104 can be performed while complying with the specification requirements. However, by sending the instruction file instead of the update file, ONUs 104 can use the instruction file as a pointer rather than the actual image of the software code that needs to be installed for the ONU configuration. This uses a data connection that is much faster than the secure software download process using OAM messages. The process also allows OLT 102 to update a large number of ONUs simultaneously because data connections are used to download the update files by ONUs, which have a much higher bandwidth and do not include the message rate limits for OAM messages.

System

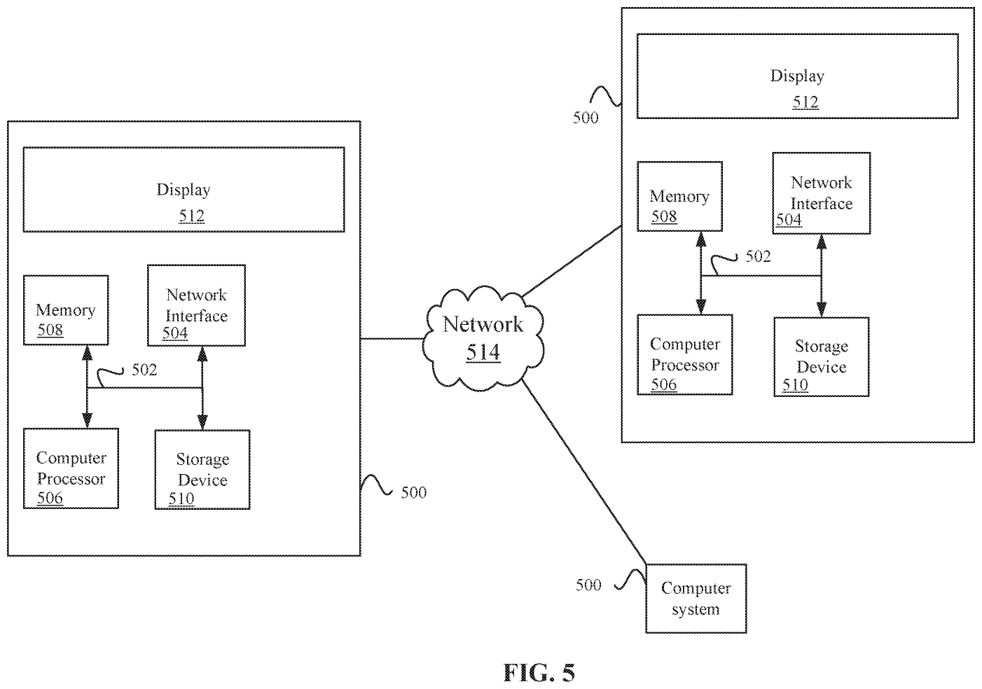

FIG. 5 illustrates an example of special purpose computer systems 500 configured with OLT 102 or ONU 104 according to some embodiments. Computer system 500 includes a bus 502, network interface 504, a computer processor 506, a memory 508, a storage device 510, and a display 512.

Bus 502 may be a communication mechanism for communicating information. Computer processor 506 may execute computer programs stored in memory 508 or storage device 510. Any suitable programming language can be used to implement the routines of some embodiments including C, C++, Java, assembly language, etc. Different programming techniques can be employed such as procedural or object oriented. The routines can execute on a single computer system 500 or multiple computer systems 500. Further, multiple computer processors 506 may be used.

Memory 508 may store instructions, such as source code or binary code, for performing the techniques described above. Memory 508 may also be used for storing variables or other intermediate information during execution of instructions to be executed by processor 506. Examples of memory 508 include random access memory (RAM), read only memory (ROM), or both.

Storage device 510 may also store instructions, such as source code or binary code, for performing the techniques described above. Storage device 510 may additionally store data used and manipulated by computer processor 506. For example, storage device 510 may be a database that is accessed by computer system 500. Other examples of storage device 510 include random access memory (RAM), read only memory (ROM), a hard drive, a magnetic disk, an optical disk, a CD-ROM, a DVD, a flash memory, a USB memory card, or any other medium from which a computer can read.

Memory 508 or storage device 510 may be an example of a non-transitory computer-readable storage medium for use by or in connection with computer system 500. The non-transitory computer-readable storage medium contains instructions for controlling a computer system 500 to be configured to perform functions described by some embodiments. The instructions, when executed by one or more computer processors 506, may be configured to perform that which is described in some embodiments.

Computer system 500 includes a display 512 for displaying information to a computer user. Display 512 may display a user interface used by a user to interact with computer system 500.

Computer system 500 also includes a network interface 504 to provide data communication connection over a network, such as a local area network (LAN) or wide area network (WAN). Wireless networks may also be used. In any such implementation, network interface 504 sends and receives electrical, electromagnetic, or optical signals that carry digital data streams representing various types of information.

Computer system 500 can send and receive information through network interface 504 across a network 514, which may be an Intranet or the Internet. Computer system 500 may interact with other computer systems 500 through network 514. In some examples, client-server communications occur through network 514. Also, implementations of some embodiments may be distributed across computer systems 500 through network 514.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A method comprising:
receiving, by a computing device, a first file for an update to a configuration, the first file sent via an operations, administration, and management message over an optical network, wherein a specification that is used to provision an optical networking unit includes a requirement that the operations, administration, and management message is to be used to update the configuration;
analyzing, by the computing device, the first file to determine the first file includes an instruction for locating a second file that includes an update to the configuration;
extracting, by the computing device, download information for the second file from the first file; and
using, by the computing device, the download information to request and download the second file via a data connection over the optical network, wherein the data connection includes a first transfer rate that is higher than a second transfer rate when using operations, administration, and management messages.

2. The method of claim 1, wherein the specification limits sending operations, administration, and management messages to the second transfer rate.

3. The method of claim 1, wherein operations, administration, and management messages are used for management of the configuration.

4. The method of claim 3, wherein the data connection is used to download data to a customer premise equipment device.

5. The method of claim 1, wherein sending the first file using the operations, administration, and management message satisfies the requirement in the specification that the configuration is to be updated using the operations, administration, and management message.

6. The method of claim 1, wherein the operations, administration, and management message is received from an optical line terminal.

7. The method of claim 1, wherein using the download information to request and download the second file comprises:
sending a request for the second file to a server; and
receiving the second file from the server.

8. The method of claim 7, wherein the server is a separate entity from an optical line terminal that sent the operations, administration, and management message.

9. The method of claim 7, wherein the server is not required to use operations, administration, and management messages to update the optical networking unit configuration.

10. The method of claim 7, wherein sending the request comprises:
using an Internet Protocol stack to send the request to the server via the optical network.

11. The method of claim 1, wherein extracting the download information comprises:
extracting server information for a server that is storing the second file and identification information that identifies the second file.

12. The method of claim 1, wherein extracting the download information comprises:
extracting protocol information for a protocol to use to send the request for the second file.

13. The method of claim 1, wherein the first file includes a link to the second file.

14. A non-transitory computer-readable storage medium containing instructions that, when executed, control a computer system to be operable for:
receiving a first file for an update to a configuration, the first file sent via an operations, administration, and management message over an optical network, wherein a specification that is used to provision an optical networking unit includes a requirement that the operations, administration, and management message is to be used to update the configuration;
analyzing the first file to determine the first file includes an instruction for locating a second file that includes an update to the configuration;
extracting download information for the second file from the first file; and
using the download information to request and download the second file via a data connection over the optical network, wherein the data connection includes a first transfer rate that is higher than a second transfer rate when using operations, administration, and management messages.

15. The non-transitory computer-readable storage medium of claim 14, wherein the specification limits sending operations, administration, and management messages to the second transfer rate.

16. The non-transitory computer-readable storage medium of claim 14, wherein sending the first file using the operations, administration, and management message satisfies the requirement in the specification that the configuration is to be updated using the operations, administration, and management message.

17. The non-transitory computer-readable storage medium of claim 14, wherein using the download information to request and download the second file comprises:
sending a request for the second file to a server; and
receiving the second file from the server.

18. The non-transitory computer-readable storage medium of claim 17, wherein the server is a separate entity from an optical line terminal that sent the operations, administration, and management message.

19. The non-transitory computer-readable storage medium of claim 17, wherein the server is not required to use operations, administration, and management messages to update an optical networking unit configuration.

20. An apparatus comprising:
one or more computer processors; and
a non-transitory computer-readable storage medium comprising instructions, that when executed, control the one or more computer processors to be operable for:
receiving a first file for an update to a configuration, the first file sent via an operations, administration, and management message over an optical network, wherein a specification that is used to provision an optical networking unit includes a requirement that the operations, administration, and management message is to be used to update the configuration;
analyzing the first file to determine the first file includes an instruction for locating a second file that includes an update to the configuration;
extracting download information for the second file from the first file; and
using the download information to request and download the second file via a data connection over the optical network, wherein the data connection includes a first transfer rate that is higher than a second transfer rate when using operations, administration, and management messages.
